(19) United States
(12) Patent Application Publication
(10) Pub. No.: US 2012/0315961 A1
(43) Pub. Date: Dec. 13, 2012

(54) DEVICE FOR DERIVING A DYNAMIC VOLTAGE SCALING DATA PROFILE

(75) Inventors: Mei Chen, Sunnyvale, CA (US); Vijay K. Chellappa, San Diego, CA (US); Sumit Verma, San Diego, CA (US); Ketan Humnabadkar, San Diego, CA (US); Bhaskar Natarajakumar, San Diego, CA (US); Carl Thomas Hardin, Encinitas, CA (US)

(73) Assignee: QUALCOMM INCORPORATED, San Diego, CA (US)

(21) Appl. No.: 13/479,141

(22) Filed: May 23, 2012

Related U.S. Application Data
(60) Provisional application No. 61/495,029, filed on Jun. 9, 2011.

(51) Int. Cl. H04W 52/02

(52) U.S. Cl. 455/574

(57) ABSTRACT

A wireless communication device for deriving a dynamic voltage scaling data profile is described. The wireless communication device includes memory that includes a dynamic voltage scaling voice profile. The wireless communication device also includes a data profile determination module coupled to the memory. The data profile determination module obtains an offset and derives a dynamic voltage scaling data profile by offsetting the dynamic voltage scaling voice profile based on the offset.

### CLAIM OF PRIORITY UNDER 35 U.S.C. §119

The present Application for Patent claims priority to Provisional Application No. 61/495,029, entitled “DEVICES AND METHODS WITH DYNAMIC VOLTAGE SCALING” filed Jun. 9, 2011, and assigned to the assignee hereof and hereby expressly incorporated by reference herein.

### TECHNICAL FIELD

The present disclosure relates generally to electronic devices. More specifically, the present disclosure relates to a device for deriving a dynamic voltage scaling data profile.

### BACKGROUND

In the last several decades, the use of electronic devices has become common In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Electronic devices may use one or more energy sources in order to function. Some electronic devices use portable energy sources, such as batteries. For example, a cellular phone may use a battery to function. As electronic technology has progressed, more efficient use of energy has been sought. For example, a cellular phone that performs functions more efficiently may have a beneficially longer battery life.

When electronic devices are manufactured, many may undergo calibration procedures in order to enable proper and efficient functioning. However, calibration procedures require time and resources. Therefore, electronic devices that require extensive calibration may be costly to manufacture. As can be observed from this discussion, systems and methods that improve efficiency and/or reduce calibration may be beneficial.

### SUMMARY

A wireless communication device for deriving a dynamic voltage scaling data profile is described. The wireless communication device includes memory that includes a dynamic voltage scaling voice profile. The wireless communication device also includes a data profile determination module coupled to the memory. The data profile determination module obtains an offset and derives a dynamic voltage scaling data profile by offsetting the dynamic voltage scaling voice profile based on the offset.

The dynamic voltage scaling voice profile may indicate supply voltages corresponding to powers for a voice waveform. The dynamic voltage scaling voice profile may be determined during calibration. The dynamic voltage scaling voice profile may be based on a power supply characterization table.

The wireless communication device may include a power supply. The power supply may provide a supply voltage to an amplifier based on the dynamic voltage scaling data profile if a data waveform is going to be transmitted. The wireless communication device may include a controller that applies a fixed voltage offset versus output power as a function of modulation type.

The memory may include a first sweep calibration table that is based on performing a first sweep calibration. The dynamic voltage scaling voice profile may be based on performing a second sweep calibration.

The data profile determination module may derive the dynamic voltage scaling data profile based on an equation V_{cc}(Data, Pₒᵤₜ)≧V_{cc}(Voice, Pₒᵤₜ+P_{offset}+1). Data may denote a data waveform, Voice may denote a voice waveform, Pₒᵤₜ may be an output power, P_{offset} may be the offset and V_{cc}( ) may indicate a supply voltage V_{cc} based on a waveform type and the output power. The dynamic voltage scaling data profile may not be based on a separate calibration for data waveforms. The offset may be a power offset. The offset may be a maximum power reduction factor.

A method for deriving a dynamic voltage scaling data profile by a wireless communication device is also described. The method includes obtaining a dynamic voltage scaling voice profile. The method also includes obtaining an offset. The method further includes deriving a dynamic voltage scaling data profile by offsetting the dynamic voltage scaling voice profile based on the offset.

A computer-program product for deriving a dynamic voltage scaling data profile is also described. The computer-program product includes a non-transitory tangible computer-readable medium with instructions. The instructions include code for causing a wireless communication device to obtain a dynamic voltage scaling voice profile. The instructions also include code for causing the wireless communication device to obtain an offset. The instructions further include code for causing the wireless communication device to derive a dynamic voltage scaling data profile by offsetting the dynamic voltage scaling voice profile based on the offset.

An apparatus for deriving a dynamic voltage scaling data profile is also described. The apparatus includes means for obtaining a dynamic voltage scaling voice profile. The apparatus also includes means for obtaining an offset. The apparatus further includes means for deriving a dynamic voltage scaling data profile by offsetting the dynamic voltage scaling voice profile based on the offset.

### BRIEF DESCRIPTION OF THE DRAWINGS

FIG. 1 is a block diagram illustrating one configuration of a wireless communication device in which systems and methods for deriving a dynamic voltage scaling data profile may be implemented;

FIG. 2 is a flow diagram illustrating one configuration of a method for deriving a dynamic voltage scaling data profile;

FIG. 3 is a flow diagram illustrating a more specific configuration of a method for deriving a dynamic voltage scaling data profile;

FIG. 4 is a block diagram illustrating a more specific configuration of a wireless communication device in which systems and methods for deriving a dynamic voltage scaling data profile may be implemented;

FIG. 5 is a flow diagram illustrating a more specific configuration of a method for deriving a dynamic voltage scaling data profile;

FIG. 6 is a block diagram illustrating one configuration of information stored in memory in accordance with some configurations of the systems and methods disclosed herein;

FIG. 7 is a flow diagram illustrating another more specific configuration of a method for deriving a dynamic voltage scaling data profile;

FIG. 8 is a block diagram illustrating more detail of a portion of one configuration of a wireless communication device in which systems and methods for deriving a dynamic voltage scaling data profile may be implemented;

FIG. 9 is a block diagram illustrating another more specific configuration of a wireless communication device in which systems and methods for deriving a dynamic voltage scaling data profile may be implemented; and

FIG. 10 illustrates certain components that may be included within a wireless communication device.

### DETAILED DESCRIPTION

The systems and methods disclosed herein may be applied to a variety of electronic devices. Examples of electronic devices include integrated circuits, cellular phones, voice recorders, video cameras, audio players (e.g., Moving Picture Experts Group-1 (MPEG-1) or MPEG-2 Audio Layer 3 (MP3) players), video players, audio recorders, laptop computers, netbook computers, tablet devices, personal digital assistants (PDAs), gaming systems, etc. One kind of electronic device is a communication device, which may communicate with another device. Examples of communication devices include telephones, laptop computers, desktop computers, cellular phones, smartphones, wireless or wired modems, e-readers, tablet devices, wireless communication devices and gaming systems.

As used herein, the terms “circuit,” “circuitry” and other variations of the term “circuit” may denote a structural element or component. For example, circuitry can be an aggregate of circuit components, such integrated circuit components, in the form of processing and/or memory cells, units, blocks and/or other components. As used herein, the term “module” may indicate that an element or component may be implemented in hardware, software or a combination of both. For example, a “module” may be implemented in circuitry, in software that is run on a processor or in a combination of both.

It should be noted that the terms “couple,” “coupling,” “coupled” or other variations of the word couple as used herein may indicate either an indirect connection or a direct connection. For example, if a first component is “coupled” to a second component, the first component may be either indirectly connected (e.g., through another component) to the second component or directly connected to the second component. Additionally, it should be noted that as used herein, designating a component, element or entity (e.g., transistor, capacitor, resistor, power supply, circuit, block/module, etc.) as a “first,” “second,” “third” or “fourth” component, etc., may be used to distinguish components for explanatory clarity. It should also be noted that labels used to designate a “second,” “third” or “fourth,” etc. do not necessarily imply that elements using preceding labels “first,” “second” or “third,” etc., are included or used.

It should be noted that the systems and methods disclosed herein may be described in terms of one or more specifications, such as the 3rd Generation Partnership Project (3GPP) Release-8 (Rel-8), 3GPP Release-9 (Rel-9), 3GPP Release-10 (Rel-10), Long-Term Evolution (LTE), LTE-Advanced (LTE-A), etc. For example, the systems and methods may be applied to devices that adhere to Universal Mobile Telecommunications System (UMTS) specifications (e.g., High-Speed Downlink Packet Access (HSDPA), High-Speed Uplink Packet Access (HSUPA), Evolved High-Speed Packet Access (HSPA+)). Additionally, they may be applied to devices that adhere to CDMA (Code Division Multiple Access) specifications such as cdmaOne, CDMA2000 or WCDMA (Wideband Code Division Multiple Access). More specific examples of CDMA specifications include RC3, RC4 and Evolution-Data Optimized (EV-DO) (e.g., Rev. 0, Rev. A, Rev. B). However, at least some of the concepts described herein may be applied to other wireless communication systems. For example, the term User Equipment (UE) may be used to refer to the more general term “wireless communication device.” Furthermore, one or more of the terms Node B, Evolved Node B (eNB), Home Evolved Node B (HeNB), etc. may be used to refer to the more general term “base station.”

The systems and methods disclosed herein describe a device for deriving a dynamic voltage scaling data profile. For example, the systems and methods disclosed herein may be applied to derive a dynamic voltage scaling (e.g., average power tracking) voltage profile for data from voice. For example, some wireless communication devices may allow for transmission of voice signals and data signals. The voice signals may exhibit a different waveform than the data signals exhibit. A dynamic voltage scaling voice profile (e.g., a dynamic voltage scaling profile for voice waveforms) may be determined during calibration. In accordance with the systems and methods disclosed herein, a dynamic voltage scaling (e.g., average power tracking) data profile may be derived from the dynamic voltage scaling voice profile. This may be done rather than performing a separate calibration for data waveforms or not having dynamic voltage scaling for data, for example.

Some approaches for data dynamic voltage scaling (DVS) schemes may include separate dynamic voltage scaling characterizations for data compared to voice. These approaches may have a disadvantage in that calibration time may increase or may result in power inaccuracies if the data traffic is not radio frequency (RF) calibrated. For instance, some average power tracking approaches utilize separately calibrated tables for voice transmission and data transmission. For example, one separate table for data or many different tables depending on data categories could be used. Unfortunately, in accordance with known approaches, each extra table for data requires factory calibration. Thus, factory calibration time may be increased with one or more tables for data. Thus, reducing the number of tables for data that requires calibration per table may be beneficial. It should be noted that having a single table for a worst case data category may reduce factory calibration time. However, this may lead to suboptimal data current consumption in mission mode (e.g., during typical operation), which may affect battery life. In one approach, no dynamic voltage scaling for data may be used. This may also require a calibration. However, even if it does not require a calibration, the resulting data current inefficiency may be high.

Dynamic voltage scaling for data transmissions is typically different compared to that for voice transmissions. The systems and methods disclosed herein describe a way to obtain a dynamic voltage scaling scheme for data transmissions that still allows voice transmissions to be improved or optimized for current consumption with an existing calibration scheme (where there is no impact to calibration time, for example). For instance, the systems and methods disclosed herein may describe a dynamic voltage scaling offset scheme for data. In some configurations, the systems and methods disclosed herein may be applied to a radio frequency transmitter (e.g., a radio frequency transmit module). For example, the systems and methods disclosed herein may relate to deriving direct current/direct current (DC/DC) or Switched Mode Power Supply (SMPS) characterization tables for data traffic in a 3G mode.

In some configurations of the systems and methods disclosed herein, a supply voltage for a power amplifier may be expressed as illustrated in Equation (1).

V_{cc}(Data, Pₒᵤₜ)≧V_{cc}(Voice, Pₒᵤₜ+P_{offset}+1) (1)

In Equation (1), V_{cc} may be a supply voltage for a power amplifier. For example, V_{cc} may refer to a pin of a power amplifier that supplies the driver and output stage of the power amplifier. The function V_{cc}(x, y) may indicate a supply voltage V_{cc} based on terms x and y, where x is a waveform type (e.g., Voice or Data) and y is an output power (e.g., Pₒᵤₜ) For example, V_{cc}(Data, Pₒᵤₜ) indicates a supply voltage V_{cc} applied to obtain a particular output power Pₒᵤₜ for a data waveform. P_{offset} may be a power offset. For example, P_{offset} may be a Maximum Power Reduction (MPR) in accordance with UMTS and/or LTE specifications. Additionally or alternatively, P_{offset} may be characterized based on hardware for CDMA specifications. Equation (1) may hold where minimum power<Pₒᵤₜ<maximum power for data transmissions.

The systems and methods disclosed herein may not require recalibration of a data path. Furthermore, a UMTS Release 99 (R99) or 1xEV-DO dynamic voltage scaling scheme can be independently improved or optimized in accordance with the systems and methods disclosed herein. For example, 1xEV-DO may be derived from a CDMA waveform (e.g., RC1 CDMA). Additionally or alternatively, UMTS may be independently optimized and HSUPA data waveforms may be derived therefrom. Some configurations of the systems and methods disclosed herein may give close to optimal gains for data in terms of current consumption. For instance, application of the systems and methods disclosed herein may provide improved energy efficiency without additional calibration time.

In some configurations, a switched mode power supply (SMPS) characterization table (for voice, for example) may be predefined by a hardware characterization. In one example, two calibration sweeps may be performed in order to establish a Release 99 (R99) SMPS to provide a lookup table index mapping. This index may reference a particular gain control setting for a transmitter in an RF transceiver. One example of an HSPA+ dynamic voltage scaling scheme is given as follows.

Table (1) illustrates one example of a switched mode power supply (SMPS) characterization table for UMTS Release 99 (R99). The SMPS characterization table may be predetermined (e.g., predefined). The SMPS characterization table may indicate an output power (in decibels (dB) referenced to 1 milliwatt (mW) or dBm) corresponding to a particular supply voltage (in volts (V)) provided by the SMPS. The SMPS characterization table may be used to derive one or more calibration tables. In other words, one or more calibration tables may be based on the SMPS characterization table.

TABLE (1)
SMPS Characterization Table for R99

| Power (dBm) | SMPS (V) |
|---|---|
| 16 | 2.2 |
| 17 | 2.3 |
| 18 | 2.4 |
| 19 | 2.5 |
| 20 | 2.6 |
| 21 | 2.8 |
| 22 | 3.1 |
| 23 | 3.4 |
| 24 | 3.4 |
| 25 | 3.4 |
| 26 | 3.4 |

During calibration, a first sweep may be performed where the supply voltage of the SMPS is kept constant (e.g., held at a nominal voltage). In Table (2), a nominal voltage of 3.4 V (e.g., source or battery voltage) provided by the SMPS is used while a lookup table index setting is varied to determine an output power (from a power amplifier, for example) corresponding to each lookup table index setting. The lookup table index settings may correspond to an internal gain setup of a transceiver (e.g., transceiver circuit). This first sweep may be performed assuming that a voice waveform or voice signal is output.

TABLE (2)
Linearizer for R99: First Sweep

| Lookup Table Index | SMPS (V) | Power (dBm) |
|---|---|---|
| 80 | 3.4 | 24 |
| 79 | 3.4 | 23 |
| 78 | 3.4 | 22 |
| 77 | 3.4 | 21 |
| 76 | 3.4 | 20 |
| 75 | 3.4 | 19 |
| 74 | 3.4 | 18 |
| 73 | 3.4 | 17 |
| 72 | 3.4 | 16 |

During calibration, a second sweep may be performed. The second sweep may be performed to determine output powers (from a power amplifier, for example) corresponding to lookup table index settings and supply voltages (from an SMPS, for example). Table (3) illustrates one example of the second sweep. Table (3) may also illustrate one example of a dynamic voltage scaling voice profile (e.g., lookup table given by V_{cc}(Voice, Pₒᵤₜ)) used to indicate a supply voltage (provided by the SMPS, for example) based on a specified output power.

TABLE (3)
Linearizer for R99: Second Sweep

| Lookup Table Index | SMPS (V) | Power (dBm) |
|---|---|---|
| 80 | 3.4 | 24.00 |
| 79 | 3.4 | 23.00 |
| 78 | 3.1 | 21.40 |
| 77 | 2.8 | 20.30 |
| 76 | 2.6 | 19.20 |
| 75 | 2.5 | 18.10 |
| 74 | 2.4 | 17.00 |
| 73 | 2.3 | 15.90 |
| 72 | 2.2 | 14.70 |

Table (4) below illustrates one example of an SMPS characterization table for data transmissions (e.g., a dynamic voltage scaling data profile) based on a dynamic voltage scaling voice profile as illustrated in Table (3). For instance, Table (4) may be derived from Table (3) based on Equation (1) illustrated above (e.g., V_{cc}(Data, Pₒᵤₜ)≧V_{cc}(Voice, Pₒᵤₜ+P_{offset}+1)). In this case, the powers from Table (3) have been shifted down by 3 dB. It should be noted that this is just one example of how to derive the dynamic voltage scaling data profile from the dynamic voltage scaling voice profile. In this example, P_{offset} is an MPR of 2 dB, V_{cc} is the SMPS output (e.g., supply voltage), Pₒᵤₜ is the output power (in dBm). It should be noted that in this example, the data transmissions may be in accordance with HSPA+ specifications.

TABLE (4)
Linearizer for HSPA 2 dB

| Lookup Table Index | SMPS (V) | Power (dBm) |
|---|---|---|
| 80 | 3.4 | 21.00 |
| 79 | 3.4 | 20.00 |
| 78 | 3.1 | 18.40 |
| 77 | 2.8 | 17.30 |
| 76 | 2.6 | 16.20 |
| 75 | 2.5 | 15.10 |
| 74 | 2.4 | 14.00 |
| 73 | 2.3 | 12.90 |
| 72 | 2.2 | 11.70 |

In accordance with the systems and methods disclosed herein, a subtest was performed to compare WCDMA versus HSUPA. A plot of WCDMA versus HSUPA showed the voltage difference on a transceiver. Adjacent carrier leakage ratio (ACLR) for HSUPA was met for all power levels. Furthermore, a plot was generated of ACLR (in decibels relative to the carrier or dBc) versus power (in dBm) for HSUPA. This plot illustrated HSUPA ACLR using an offset average power tracking table. Some configurations of the systems and methods disclosed herein derive HSPA+ tables for all data waveforms in UMTS with no additional characterization and provide WCDMA current consumption improvement (e.g., optimization) without the need for extra calibration.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

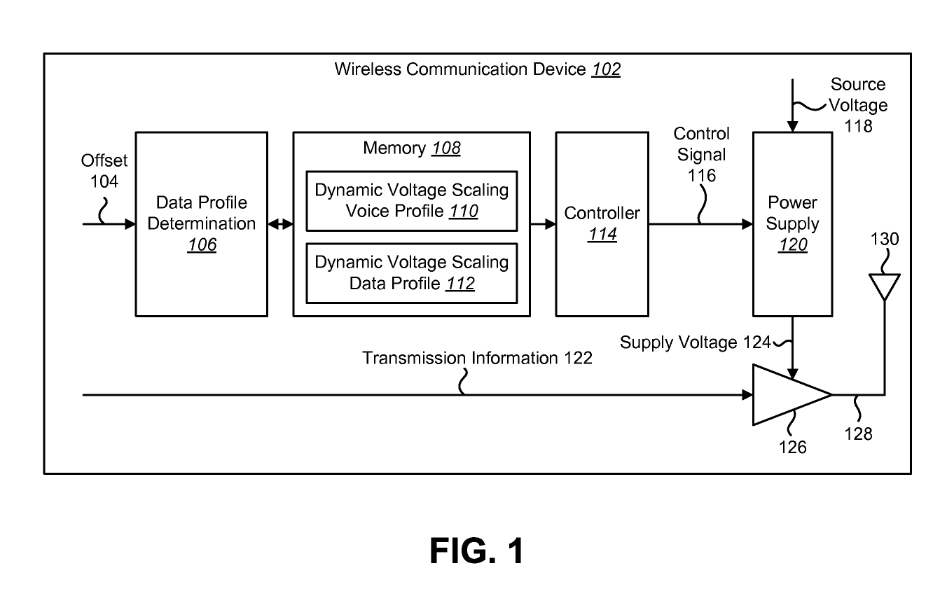

FIG. 1 is a block diagram illustrating one configuration of a wireless communication device 102 in which systems and methods for deriving a dynamic voltage scaling data profile 112 may be implemented. The wireless communication device 102 includes a data profile determination module 106, memory 108, a controller 114, a power supply 120, an amplifier 126 and/or an antenna 130. One or more of the elements included within the wireless communication device 102 may be implemented in hardware, software or a combination of both. For example, the data profile determination module 106 may be implemented as circuitry, as a processor with instructions or as a combination thereof In some configurations, the data profile determination module 106 may be coupled to the memory 108, the memory 108 may be coupled to the controller 114, the controller 114 may be coupled to the power supply 120, the power supply 120 may be coupled to the amplifier 126 and/or the amplifier 126 may be coupled to the antenna 130.

The memory 108 may include a dynamic voltage scaling voice profile 110. The dynamic voltage scaling voice profile 110 may indicate particular supply voltages 124 corresponding to powers at the output 128 of the amplifier 126 for a voice waveform. For example, the dynamic voltage scaling voice profile 110 may specify a supply voltage 124 for the amplifier 126 to produce a specified power at the output 128 when transmission information 122 is a voice waveform. In some configurations, the dynamic voltage scaling voice profile 110 may be a lookup table.

The dynamic voltage scaling voice profile 110 may be determined during calibration of the wireless communication device 102. For example, the wireless communication device 102 may perform calibration procedures in order to set the dynamic voltage scaling voice profile 110. This may be done when the wireless communication device 102 is manufactured, for instance.

The data profile determination module 106 may determine (e.g., derive, generate) a dynamic voltage scaling data profile 112, which may be provided to and stored in memory 108. The data profile determination 106 module may derive the dynamic voltage scaling data profile 112 based on the dynamic voltage scaling voice profile 110 and an offset 104. This approach may avoid the need to perform a separate calibration for data waveforms. In other words, the dynamic voltage scaling data profile 112 may be based on the dynamic voltage scaling voice profile 110 and may not be based on a separate calibration for data waveforms.

In some configurations, the offset 104 may be received from another communication device (e.g., base station). In some configurations, the offset 104 may be derived based on feedback (e.g., channel feedback) from another communication device (e.g., base station). One example of the offset 104 may be a Maximum Power Reduction (MPR) factor according to UMTS and/or LTE specifications. For instance, MPR may specify an amount of backoff (e.g., reduction in transmission power). In other examples (e.g., in accordance with CDMA specifications), the offset 104 may be characterized based on the hardware (e.g., based on characteristics of the wireless communication device 102).

In some configurations, the data profile determination module 106 may determine the dynamic voltage scaling data profile 112 based on Equation (1). In these configurations, V_{cc} is the supply voltage 124, P_{offset} is the offset 104, Pₒᵤₜ is the output power at the output 128 of the amplifier 126, Voice denotes the dynamic voltage scaling voice profile 110 (to be applied when the transmission information 122 is a voice waveform, for example) and Data denotes the dynamic voltage scaling data profile 112 (to be applied when the transmission information 122 is a data waveform, for example).

A voice waveform may be voice information that is formatted (e.g., encoded) particular to voice. One example of a voice waveform is voice information encoded using code excited linear prediction (CELP) encoding. In WCDMA, examples of voice waveforms may include a dedicated physical control channel (DPCCH) for control information and a dedicated physical data control channel (DPDCH) for data. A data waveform may be information that is formatted (e.g., encoded) for transmission as data. HSPA+ data waveforms may include the two voice channels in addition to enhanced uplink channels (e.g., E-DPCCH and E-DPDCH). It should be noted that in some configurations, voice information may be formatted to be transmitted as data. Voice Over Internet Protocol (VOIP) is one example where voice information may be formatted to be transmitted as data.

The dynamic voltage scaling voice profile 110 and/or the dynamic voltage scaling data profile 112 may be provided to the controller 114. The controller 114 may provide a control signal 116 to the power supply 120 in order to control the power supply 120 based on the dynamic voltage scaling voice profile 110 and/or the dynamic voltage scaling data profile 112. For example, when the transmission information 122 is a voice waveform, the controller 114 may produce a control signal 116 based on the dynamic voltage scaling voice profile 110 that causes the power supply 120 to produce a particular supply voltage 124 (corresponding to a specified power at the output 128 of the amplifier 126, for instance). However, when the transmission information 122 is a data waveform, the controller 114 may produce a control signal 116 based on the dynamic voltage scaling data profile 112 that causes the power supply 120 to produce a particular supply voltage 124 (corresponding to a specified power at the output 128 of the amplifier 126, for instance). In some configurations, the controller 114 may apply a fixed voltage offset (or cause a fixed voltage offset to be applied by the power supply 120, for example) for the dynamic voltage scaling (e.g., average power tracking) versus output power (e.g., power at the output 128) as a function of modulation type. For example, a particular modulation type (e.g., quadrature amplitude modulation (QAM), phase-shift keying (PSK), etc.) may be applied to the transmission information 122. The controller 114 may apply a fixed voltage offset based on the modulation type. For example, a supply voltage offset may be applied based on whether the modulation type is LTE quadrature phase-shift keying (QPSK) or LTE 16-QAM. LTE QPSK may have a more “aggressive” voltage (akin to voice), while LTE 16QAM may behave more data-like, for instance.

The power supply 120 may produce a supply voltage 124 based on a source voltage 118. For example, the power supply 120 may maintain or reduce the source voltage 118 to produce the supply voltage 124. In some cases, the source voltage 118 may be referred to as a nominal voltage (and the supply voltage 124 may be referred to as a nominal voltage when it is approximately the same as the source voltage 118). The source voltage 118 may be provided by a battery, a wall outlet or other power source. The supply voltage 124 produced by the power supply 120 may be based on the control signal 116 as described above. One example of the power supply 120 is a switched mode power supply (SMPS).

The amplifier 126 may amplify the transmission information 122 based on the supply voltage 124. For example, the amount of voltage provided by the supply voltage 124 may determine the amount of amplification provided by the amplifier 126. One example of the amplifier 126 is a power amplifier (PA). The output 128 of the amplifier 126 may be coupled to an antenna 130. The antenna 130 may transmit (e.g., radiate) the transmission information 122 that has been amplified by the amplifier 126.

It should be noted that the systems and methods disclosed herein may be applied to multiple transmit paths. For example, the wireless communication device 102 may include multiple amplifiers 126 and multiple antennas 130 in some configurations.

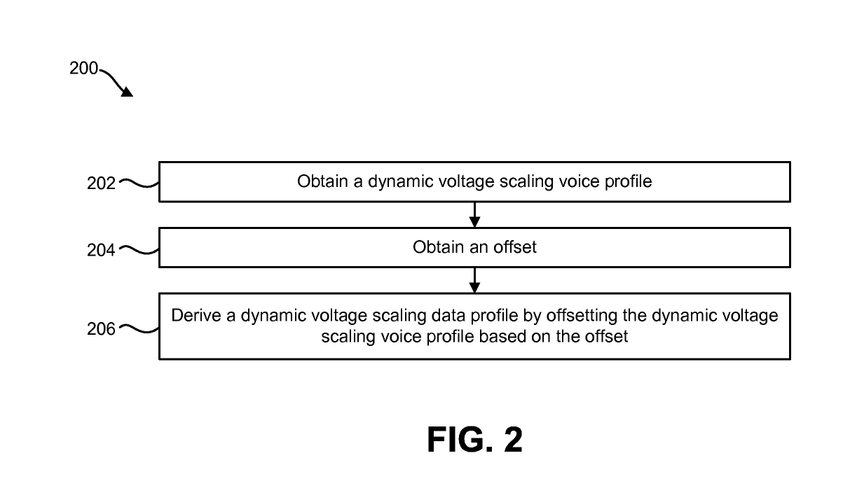

FIG. 2 is a flow diagram illustrating one configuration of a method 200 for deriving a dynamic voltage scaling data profile 112. A wireless communication device 102 may obtain 202 a dynamic voltage scaling voice profile 110. For example, the wireless communication device 102 may obtain 202 the dynamic voltage scaling voice profile 110 during calibration of the wireless communication device 102. For instance, the wireless communication device 102 may perform calibration procedures in order to set the dynamic voltage scaling voice profile 110. This may be done when the wireless communication device 102 is manufactured, for instance. In some configurations, the wireless communication device 102 may obtain 202 the dynamic voltage scaling voice profile 110 based on a characterization table and one or more calibration sweeps.

The wireless communication device 102 may obtain 204 an offset 104. In some configurations, the offset 104 may be received from another communication device (e.g., base station). In some configurations, the offset 104 may be derived based on feedback (e.g., channel feedback) from another communication device (e.g., base station). One example of the offset 104 may be a Maximum Power Reduction (MPR) factor according to UMTS and/or LTE specifications. For instance, MPR may specify an amount of backoff (e.g., reduction in transmission power). In other examples (e.g., in accordance with CDMA specifications), the offset 104 may be characterized based on the hardware (e.g., based on characteristics of the wireless communication device 102).

The wireless communication device 102 may derive 206 a dynamic voltage scaling data profile 112 by offsetting the dynamic voltage scaling voice profile 110 based on the offset 104. For example, the wireless communication device 102 may derive 206 the dynamic voltage scaling data profile 112 based on Equation (1). In these configurations, V_{cc} is the supply voltage 124, P_{offset} is the offset 104, Pₒᵤₜ is the output power at the output 128 of the amplifier 126, Voice denotes the dynamic voltage scaling voice profile 110 (to be applied when the transmission information 122 is a voice waveform, for example) and Data denotes the dynamic voltage scaling data profile 112 (to be applied when the transmission information 122 is a data waveform, for example). This approach may avoid the need to perform a separate calibration for data waveforms.

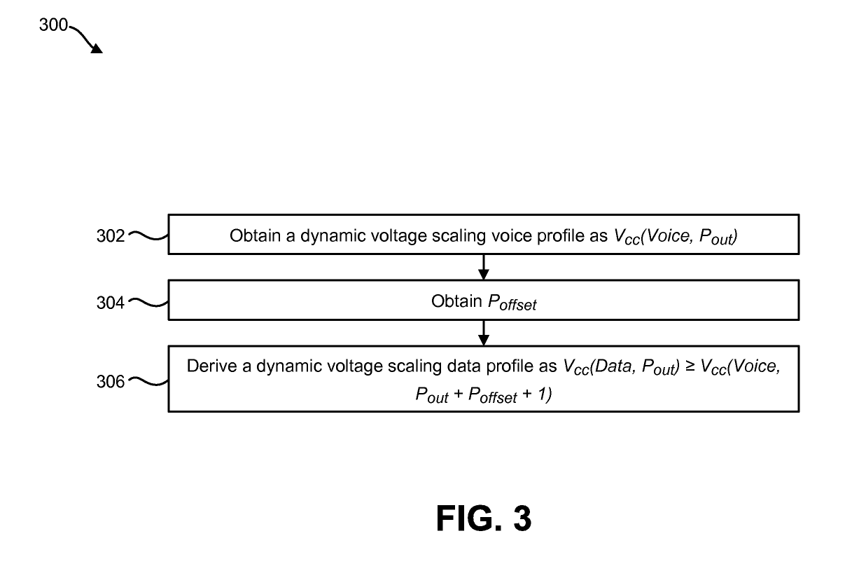

FIG. 3 is a flow diagram illustrating a more specific configuration of a method 300 for deriving a dynamic voltage scaling data profile 112. A wireless communication device 102 may obtain 302 a dynamic voltage scaling voice profile 110 as V_{cc}(Voice, Pₒᵤₜ). V_{cc} is the supply voltage 124, Pₒᵤₜ is the output power at the output 128 of the amplifier 126 and Voice denotes the dynamic voltage scaling voice profile 110 (to be applied when the transmission information 122 is a voice waveform, for example).

For example, the wireless communication device 102 may obtain 302 the dynamic voltage scaling voice profile 110 V_{cc}(Voice, Pₒᵤₜ) during calibration of the wireless communication device 102. For instance, the wireless communication device 102 may perform calibration procedures in order to set the dynamic voltage scaling voice profile 110 V_{cc}(Voice, Pₒᵤₜ). This may be done when the wireless communication device 102 is manufactured, for instance. In some configurations, the wireless communication device 102 may obtain 302 the dynamic voltage scaling voice profile V_{cc}(Voice, Pₒᵤₜ) based on a characterization table and one or more calibration sweeps.

The wireless communication device 102 may obtain 304 P_{offset} (e.g., a power offset). In some configurations, P_{offset} may be received from another communication device (e.g., base station). In some configurations, P_{offset} may be derived based on feedback (e.g., channel feedback) from another communication device (e.g., base station). One example of P_{offset} may be a Maximum Power Reduction (MPR) factor according to UMTS and/or LTE specifications. For instance, MPR may specify an amount of backoff (e.g., reduction in transmission power). In other examples (e.g., in accordance with CDMA specifications), P_{offset} may be characterized based on the hardware (e.g., based on characteristics of the wireless communication device 102).

The wireless communication device 102 may derive 306 a dynamic voltage scaling data profile 112 as V_{cc}(Data, Pₒᵤₜ)≧V_{cc}(Voice, Pₒᵤₜ+P_{offset}+1). For example, the wireless communication device 102 may derive 306 the dynamic voltage scaling data profile 112 based on Equation (1). V_{cc} is the supply voltage 124, P_{offset} is the offset 104, Pₒᵤₜ is the output power at the output 128 of the amplifier 126, Voice denotes the dynamic voltage scaling voice profile 110 (to be applied when the transmission information 122 is a voice waveform, for example) and Data denotes the dynamic voltage scaling data profile 112 (to be applied when the transmission information 122 is a data waveform, for example). It should be noted that the dynamic voltage scaling data profile 112 may be derived 306 during manufacturing (without additional calibration, for example) or during runtime.

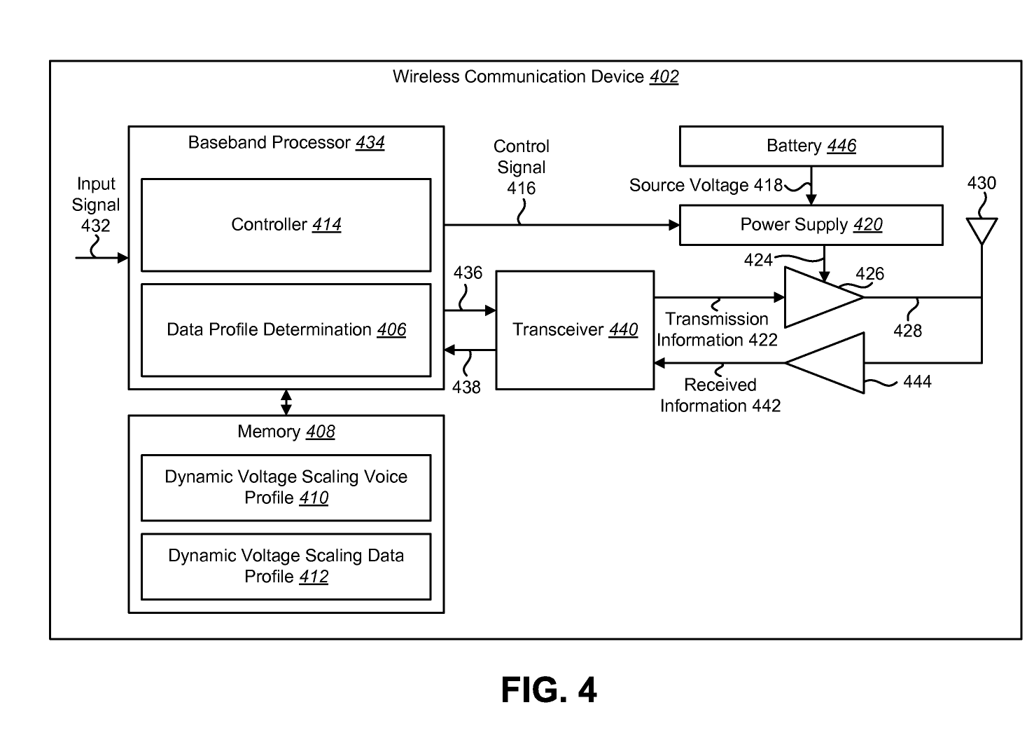

FIG. 4 is a block diagram illustrating a more specific configuration of a wireless communication device 402 in which systems and methods for deriving a dynamic voltage scaling data profile may be implemented. The wireless communication device 402 includes a baseband processor 434, memory 408, a transceiver 440, a battery 446, a power supply 420, a transmit amplifier 426, a receive amplifier 444 and/or an antenna 430. One or more of the elements included within the wireless communication device 402 may be implemented in hardware (e.g., circuitry), software or a combination of both. For example, the baseband processor 434 may be implemented as circuitry, as a processor with instructions or as a combination thereof. In some configurations, the baseband processor 434 may be coupled to the memory 408, to the power supply 420 and to the transceiver 440. The power supply 420 may be coupled to the battery 446 and to the transmit amplifier 426. The transceiver 440 may be coupled to the transmit amplifier 426 and to the receive amplifier 444, which may be coupled to the antenna 430.

The baseband processor 434 may include a controller 414 and a data profile determination module 406. The baseband processor 434 may obtain an input signal 432. The input signal 432 may be a voice signal and/or a data signal. The baseband processor 434 may process the input signal 432 to produce baseband transmit information 436. For example, the baseband processor 434 may modulate the input signal 432 and convert it 432 to an analog signal to produce the baseband transmit information 436. The baseband transmit information 436 may be provided to the transceiver 440. The transceiver 440 may upconvert the baseband transmit information 436 to produce transmission information 422, which is provided to the transmit amplifier 426. The transmission information 422 may be a voice waveform or a data waveform.

The memory 408 may include a dynamic voltage scaling voice profile 410. The dynamic voltage scaling voice profile 410 may indicate particular supply voltages 424 corresponding to powers at the output 428 of the transmit amplifier 426 for a voice waveform. For example, the dynamic voltage scaling voice profile 410 may specify a supply voltage 424 for the transmit amplifier 426 to produce a specified power at the output 428 when transmission information 422 is a voice waveform. In some configurations, the dynamic voltage scaling voice profile 410 may be a lookup table.

The dynamic voltage scaling voice profile 410 may be determined during calibration of the wireless communication device 402. For example, the wireless communication device 402 may perform calibration procedures in order to set the dynamic voltage scaling voice profile 410. This may be done when the wireless communication device 402 is manufactured, for instance.

The data profile determination module 406 may determine (e.g., derive, generate) a dynamic voltage scaling data profile 412, which may be provided to and stored in memory 408. The data profile determination 406 module may derive the dynamic voltage scaling data profile 412 based on the dynamic voltage scaling voice profile 410 and an offset. This approach may avoid the need to perform a separate calibration for data waveforms.

In some configurations, the offset may be received from another communication device (e.g., base station). In some configurations, the offset may be derived based on feedback (e.g., channel feedback) from another communication device (e.g., base station). For instance, the wireless communication device 402 may receive a signal using the antenna 430 that is amplified by the receive amplifier 444 (e.g., low noise amplifier (LNA)) to produce received information 442. The received information 442 may be provided to the transceiver 440, which may downconvert the received information 442 into baseband received information 438, which is provided to the baseband processor 434. In some configurations, the offset or the feedback information may be included in the received baseband information 438. One example of the offset may be a Maximum Power Reduction (MPR) factor according to UMTS and/or LTE specifications. For instance, MPR may specify an amount of backoff (e.g., reduction in transmission power). In other examples (e.g., in accordance with CDMA specifications), the offset may be characterized based on the hardware (e.g., based on characteristics of the wireless communication device 402).

In some configurations, the data profile determination module 406 may determine the dynamic voltage scaling data profile 412 based on Equation (1). In these configurations, V_{cc} is the supply voltage 424, P_{offset} is the offset, Pₒᵤₜ is the output power at the output 428 of the transmit amplifier 426, Voice denotes the dynamic voltage scaling voice profile 410 (to be applied when the transmission information 422 is a voice waveform, for example) and Data denotes the dynamic voltage scaling data profile 412 (to be applied when the transmission information 422 is a data waveform, for example).

A voice waveform may be voice information (in the input signal 432) that is formatted (e.g., encoded) particular to voice. A data waveform may be information that is formatted (e.g., encoded) for transmission as data.

The dynamic voltage scaling voice profile 410 and/or the dynamic voltage scaling data profile 412 may be provided to the controller 414. The controller 414 may provide a control signal 416 to the power supply 420 in order to control the power supply 420 based on the dynamic voltage scaling voice profile 410 and/or the dynamic voltage scaling data profile 412. For example, when the transmission information 422 is a voice waveform, the controller 414 may produce a control signal 416 based on the dynamic voltage scaling voice profile 410 that causes the power supply 420 to produce a particular supply voltage 424 (corresponding to a specified power at the output 428 of the transmit amplifier 426, for instance). However, when the transmission information 422 is a data waveform, the controller 414 may produce a control signal 416 based on the dynamic voltage scaling data profile 412 that causes the power supply 420 to produce a particular supply voltage 424 (corresponding to a specified power at the output 428 of the transmit amplifier 426, for instance).

The power supply 420 may produce a supply voltage 424 based on a source voltage 418. For example, the power supply 420 may maintain or reduce the source voltage 418 to produce the supply voltage 424. In some cases, the source voltage 418 may be referred to as a nominal voltage (and the supply voltage 424 may be referred to as a nominal voltage when it is approximately the same as the source voltage 418). The source voltage 418 is provided by the battery 446. The supply voltage 424 produced by the power supply 420 may be based on the control signal 416 as described above. One example of the power supply 420 is a switched mode power supply (SMPS).

The transmit amplifier 426 may amplify the transmission information 422 based on the supply voltage 424. For example, the amount of voltage provided by the supply voltage 424 may determine the amount of amplification provided by the transmit amplifier 426. One example of the transmit amplifier 426 is a power amplifier (PA). The output 428 of the transmit amplifier 426 may be coupled to an antenna 430. The antenna 430 may transmit (e.g., radiate) the transmission information 422 that has been amplified by the transmit amplifier 426.

It should be noted that the systems and methods disclosed herein may be applied to multiple transmit paths. For example, the wireless communication device 402 may include multiple transmit amplifiers 426 and multiple antennas 430 in some configurations.

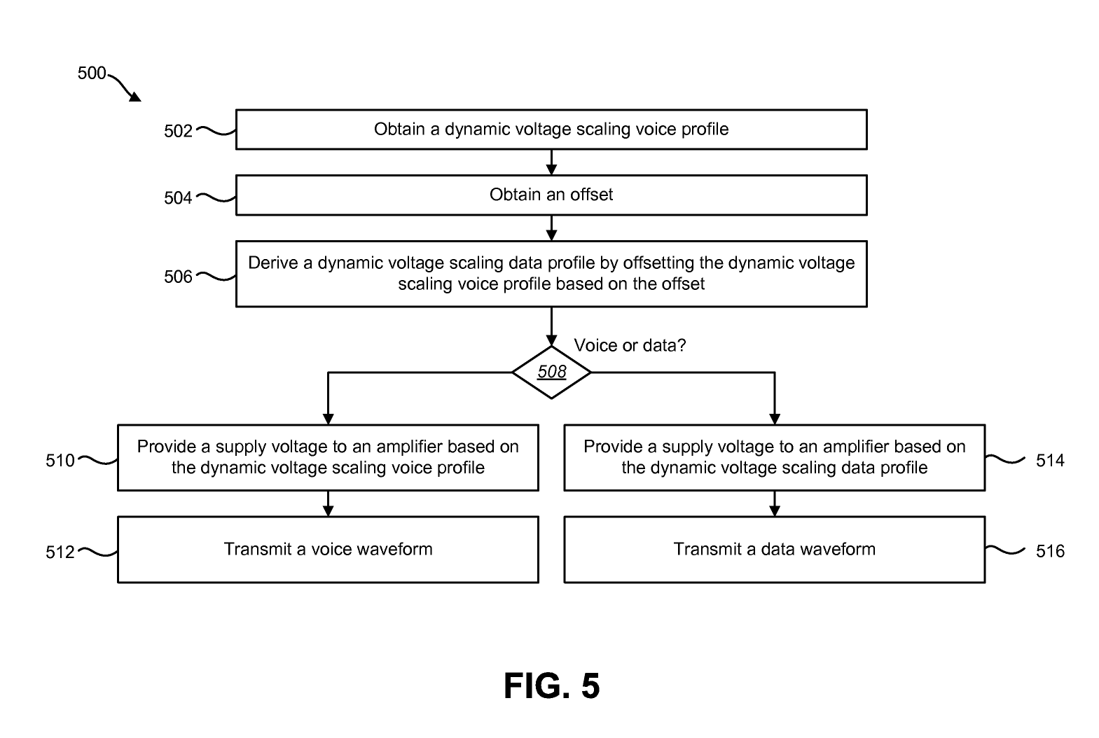

FIG. 5 is a flow diagram illustrating a more specific configuration of a method 500 for deriving a dynamic voltage scaling data profile 412. A wireless communication device 402 may obtain 502 a dynamic voltage scaling voice profile 410. For example, the wireless communication device 402 may obtain 502 the dynamic voltage scaling voice profile 410 during calibration of the wireless communication device 402. For instance, the wireless communication device 402 may perform calibration procedures in order to set the dynamic voltage scaling voice profile 410. This may be done when the wireless communication device 402 is manufactured, for instance. In some configurations, the wireless communication device 402 may obtain 502 the dynamic voltage scaling voice profile 410 based on a characterization table and one or more calibration sweeps.

The wireless communication device 402 may obtain 504 an offset. In some configurations, the offset may be received from another communication device (e.g., base station). In some configurations, the offset may be derived based on feedback (e.g., channel feedback) from another communication device (e.g., base station).

The wireless communication device 402 may derive 506 a dynamic voltage scaling data profile 412 by offsetting the dynamic voltage scaling voice profile 410 based on the offset. For example, the wireless communication device 402 may derive 506 the dynamic voltage scaling data profile 412 based on Equation (1).

The wireless communication device 402 may determine 508 whether a voice waveform or a data waveform is going to be transmitted. For example, the baseband processor 434 may determine whether the input signal 432 is a voice signal or a data signal. In some configurations, this determination 508 may be based on the encoding of the input signal 432. For example, a voice signal may be encoded differently from a data signal. Additionally or alternatively, the baseband processor 434 may receive an indicator (from a voice encoder, data encoder, application processor, etc.) that indicates whether the input signal 432 is voice or data. Additionally or alternatively, the input signal 432 may include metadata that specifies whether the input signal 432 is a voice signal or a data signal. As noted above, a data signal may include voice information in some cases (e.g., for VOIP).

If the wireless communication device 402 determines 508 that a voice waveform is going to be transmitted, the wireless communication device 402 (e.g., power supply 420) may provide 510 a supply voltage 424 to an amplifier 426 based on the dynamic voltage scaling voice profile 410. The wireless communication device 402 (e.g., transceiver 440) may transmit 512 a voice waveform. For example, the wireless communication device 402 may transmit 512 a voice waveform that has been amplified by the amplifier 426 based on the dynamic voltage scaling voice profile 410.

If the wireless communication device 402 determines 508 that a data waveform is going to be transmitted, the wireless communication device 402 (e.g., power supply 420) may provide 514 a supply voltage 424 to an amplifier 426 based on the dynamic voltage scaling data profile 412. The wireless communication device 402 (e.g., transceiver 440) may transmit 516 a data waveform. For example, the wireless communication device 402 may transmit 516 a data waveform that has been amplified by the amplifier 426 based on the dynamic voltage scaling data profile 412.

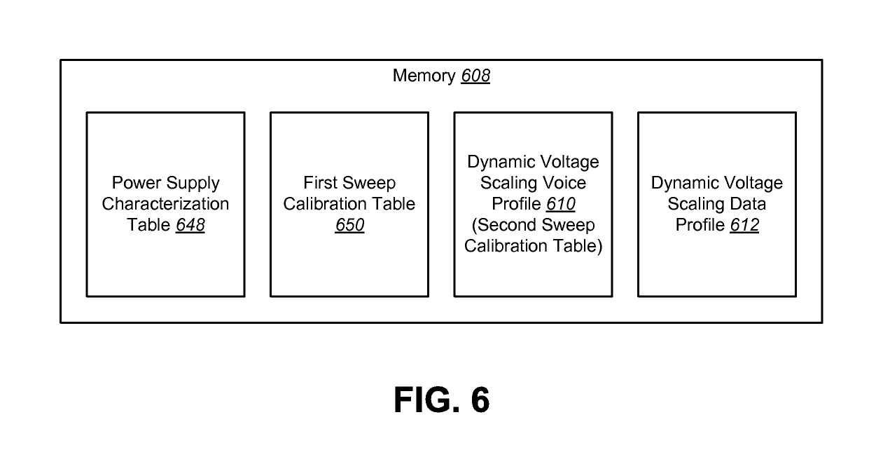

FIG. 6 is a block diagram illustrating one configuration of information stored in memory 608 in accordance with some configurations of the systems and methods disclosed herein. The memory 608 may be a more specific example of memory 108, 408 described above. In this configuration illustrated in FIG. 6, the memory 608 includes a power supply characterization table 648. One example of the power supply characterization table 648 is given in Table (1) above.

The power supply characterization table 648 may be predetermined (e.g., predefined). The power supply characterization table 648 may indicate an output power (in dBm, for example) corresponding to a particular supply voltage (in V, for example) provided by the power supply (e.g., power supply 120). The power supply characterization table 648 may be used to obtain one or more additional calibration tables (e.g., a first sweep calibration table 650 and a dynamic voltage scaling voice profile 610 (e.g., a second sweep calibration table 610)). One example in which the characterization table can be used in the two calibration sweeps is given as follows. In the first sweep, the voltage bias (e.g., supply voltage) is fixed to a constant value. A relation is established between the look up table index value and an output power at a fixed higher bias. In the second sweep, the voltage bias is applied to each look up table index based on the power determined for this index from the first sweep and that power level is associated with a voltage bias based on the pre-characterized table.

During calibration, a first sweep may be performed where the supply voltage of the power supply is kept constant (e.g., held at a nominal voltage). For example, a first sweep calibration table 650 may be determined by keeping the supply voltage constant while varying a lookup table index setting. One example of the first sweep calibration table 650 is given in Table (2) above. The first sweep calibration table 650 may be based on the power supply characterization table 648. The lookup table index settings may correspond to an internal gain setup of a transceiver (e.g., transceiver 440). This first sweep may be performed assuming that a voice waveform or voice signal is output.

During calibration, a second sweep may be performed to obtain the dynamic voltage scaling voice profile 610 (or second sweep calibration table). The dynamic voltage scaling voice profile 610 (second sweep calibration table) may be based on the power supply characterization table 648. The second sweep may be performed to determine output powers (from a power amplifier, for example) corresponding to lookup table index settings and supply voltages (from a power supply 120, 420, for example). Table (3) above illustrates one example of the second sweep. Table (3) may also illustrate one example of a dynamic voltage scaling voice profile 610 (e.g., lookup table) used to indicate a supply voltage (provided by the power supply, for example) based on a specified output power.

A dynamic voltage scaling data profile 612 may be derived based on the dynamic voltage scaling voice profile 610. For instance, the dynamic voltage scaling data profile 612 may be derived from the dynamic voltage scaling voice profile 610 based on Equation (1) illustrated above (e.g., V_{cc}(Data, Pₒᵤₜ)≧V_{cc}(Voice, Pₒᵤₜ+P_{offset}+1)). Table (4) above may be one example of the dynamic voltage scaling data profile 612.

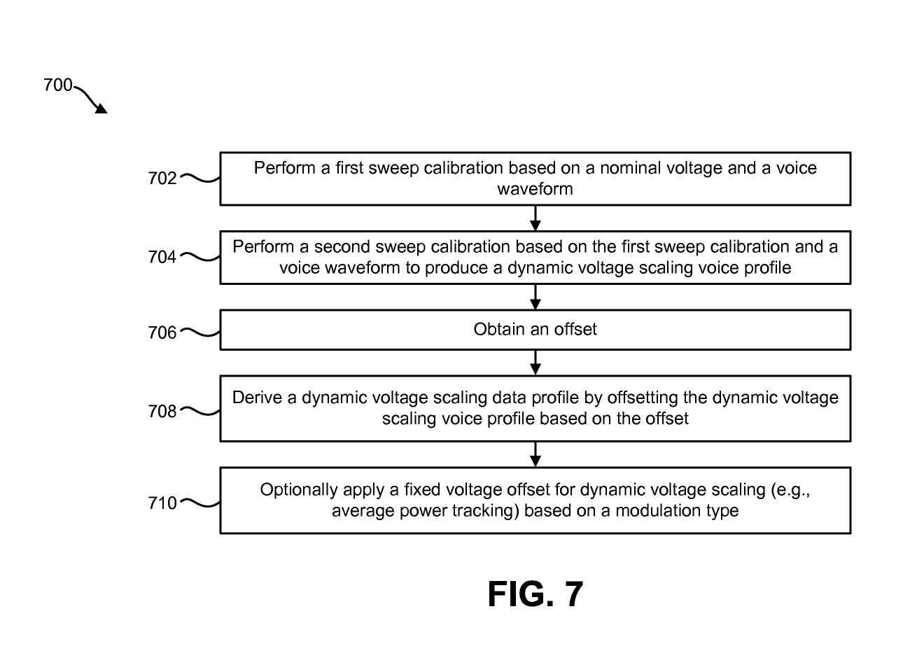

FIG. 7 is a flow diagram illustrating another more specific configuration of a method 700 for deriving a dynamic voltage scaling data profile 112. A wireless communication device 102 may perform 702 a first sweep calibration based on a nominal voltage and a voice waveform. Performing 702 the first sweep calibration may produce a first sweep calibration table (e.g., the first sweep calibration table 650 included in memory 608). For example, the wireless communication device 102 may provide a fixed supply voltage 124 to the amplifier 126 while adjusting (e.g., “sweeping”) lookup table index settings. A voice waveform may be provided to the amplifier 126 while performing 702 the first sweep calibration. The resulting power at each lookup table index setting may be measured at the output 128 of the amplifier. The lookup table index settings and corresponding output 128 power for the voice waveform may be stored in memory 108 as a first sweep calibration table 650, for example. One example of the first sweep calibration table 650 is illustrated in Table (2) above.

The wireless communication device 102 may perform 704 a second sweep calibration based on the first sweep calibration and the voice waveform to produce a dynamic voltage scaling voice profile 110 (e.g., dynamic voltage scaling voice profile 610 (second sweep calibration table)). In performing 704 the second sweep calibration, the wireless communication device 102 may vary both lookup table index settings and the supply voltage 124 while providing a voice waveform to the amplifier 126. The resulting power at the output 128 of the amplifier 126 may be measured. Lookup table index settings, supply voltage 124 levels and corresponding output powers for the voice waveform may be stored in memory 108 as a dynamic voltage scaling voice profile 110 (e.g., dynamic voltage scaling voice profile 610 (second sweep calibration table)).

The wireless communication device 102 may obtain 706 an offset 104. The offset 104 may be a power offset. In some configurations, the offset 104 may be received from another communication device (e.g., base station). In some configurations, the offset 104 may be derived based on feedback (e.g., channel feedback) from another communication device (e.g., base station). One example of the offset 104 may be a Maximum Power Reduction (MPR) factor according to UMTS and/or LTE specifications. For instance, MPR may specify an amount of backoff (e.g., reduction in transmission power). In other examples (e.g., in accordance with CDMA specifications), the offset 104 may be characterized based on the hardware (e.g., based on characteristics of the wireless communication device 102).

The wireless communication device 102 may derive 708 a dynamic voltage scaling data profile 112 by offsetting the dynamic voltage scaling voice profile 110 based on the offset 104. For example, the wireless communication device 102 may derive 708 the dynamic voltage scaling data profile 112 based on Equation (1). In these configurations, V_{cc} is the supply voltage 124, P_{offset} is the offset 104, Pₒᵤₜ is the output power at the output 128 of the amplifier 126, Voice denotes the dynamic voltage scaling voice profile 110 (to be applied when the transmission information 122 is a voice waveform, for example) and Data denotes the dynamic voltage scaling data profile 112 (to be applied when the transmission information 122 is a data waveform, for example). One example of the dynamic voltage scaling data profile 112 (e.g., dynamic voltage scaling data profile 612) is illustrated in Table (4) above. This approach may avoid the need to perform a separate calibration for data waveforms.

The wireless communication device 102 may optionally apply 710 a fixed voltage offset for dynamic voltage scaling (e.g., average power tracking) versus output power as a function of modulation type. For example, the wireless communication device 102 may apply a fixed voltage offset based on a type of modulation applied to transmission information 122.

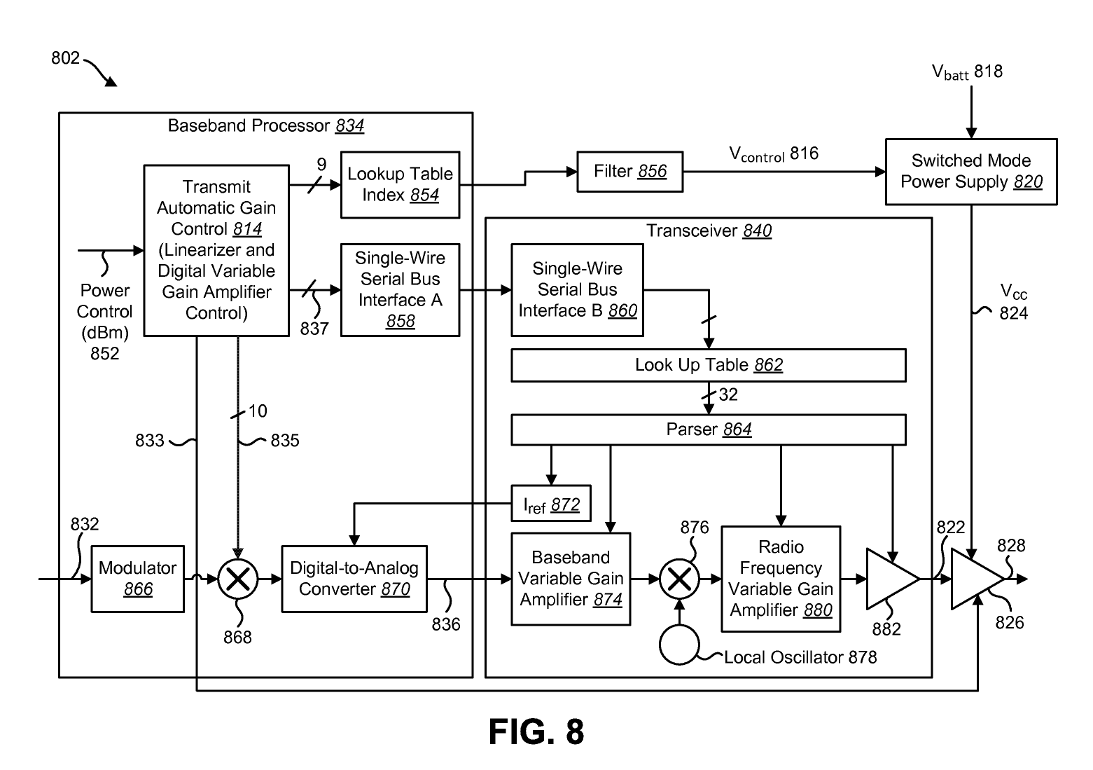

FIG. 8 is a block diagram illustrating more detail of a portion of one configuration of a wireless communication device 802 in which systems and methods for deriving a dynamic voltage scaling data profile may be implemented. The wireless communication device 802 includes a baseband processor 834, memory (not illustrated in FIG. 8) coupled to the baseband processor 834, a transceiver 840, a battery (not illustrated in FIG. 8), a filter 856, a switched mode power supply 820, a power amplifier 826 and/or an antenna (not illustrated in FIG. 8). One or more of the elements included within the wireless communication device 802 may be implemented in hardware (e.g., circuitry), software or a combination of both. For example, the baseband processor 834 may be implemented as circuitry, as a processor with instructions or as a combination thereof In some configurations, the baseband processor 834 may be coupled to the memory, to the switched mode power supply 820 and to the transceiver 840. The switched mode power supply 820 may be coupled to the battery and to the power amplifier 826. The transceiver 840 may be coupled to the power amplifier 826, which may be coupled to the antenna.

The baseband processor 834 may include a transmit automatic gain control module 814 (e.g., linearizer and digital variable gain control amplifier control), a modulator 866, a first mixer 868, a digital-to-analog converter 870, a lookup table index module 854 and single-wire serial bus interface A 858. The baseband processor 834 may obtain an input signal 832. The input signal 832 may be a voice signal and/or a data signal. The baseband processor 834 may process the input signal 832 to produce baseband transmit information 836. For example, the modulator 866 may modulate the input signal 832, which may be scaled by the first mixer 868 (using β′ or in-phase and quadrature (IQ) scaling, for example) and converted to an analog signal by the digital-to-analog converter 870 to produce the baseband transmit information 836. In some configurations, the transmit automatic gain control module 814 may apply a fixed voltage offset for the dynamic voltage scaling (e.g., average power tracking) versus output power (e.g., power at the output 828) as a function of modulation type applied by the modulator 866.

The transmit automatic gain control module 814 may control gain aspects of the baseband processor 834, the transceiver 840 and the power amplifier 826 in order to achieve a particular power at the output 828 of the power amplifier 826. For example, the transmit automatic gain control module 814 may provide a gain range control signal 833 to the power amplifier 826 that selects a particular gain range for the power amplifier 826.

The scaling performed by the first mixer 868 may be controlled by transmit automatic gain control module 814. For example, the transmit automatic gain control module 814 may provide a digital gain control signal 835 to the first mixer 868 that determines the extent of scaling performed by the first mixer 868.

The transmit automatic gain control module 814 may also provide a transceiver gain control signal 837 to the transceiver 840 via single-wire serial bus interface A 858 and single-wire serial bus interface B 860. The transceiver gain control signal 837 may be provided to a lookup table 862 in the transceiver 840 that provides values to a parser 864. For example, the parser 864 may be a logical parser that parses a gain control word to distribute the gain amongst the various blocks (e.g., I_{ref}, module 872, baseband variable gain amplifier 874, radio frequency variable gain amplifier 880 and/or a driver amplifier 882) in the transmitter. For instance, the parser 864 may provide a reference current through an I_{ref} module 872 to the digital-to-analog converter 870 and may control the gain of the baseband variable gain amplifier 874, the radio frequency variable gain amplifier 880 and the driver amplifier 882.

The baseband transmit information 836 may be provided to the transceiver 840. The baseband transmit information 836 may be amplified by the baseband variable gain amplifier 874, upconverted by a second mixer 876 based on a signal from a local oscillator 878, amplified by the radio frequency variable gain amplifier 880 and amplified by the DA 882 to produce transmission information 822. The transmission information 822 may be provided to the power amplifier 826. The transmission information 822 may be a voice waveform or a data waveform.

The memory may include a dynamic voltage scaling voice profile. The dynamic voltage scaling voice profile may indicate particular supply voltages 824 corresponding to powers at the output 828 of the power amplifier 826 for a voice waveform. For example, the dynamic voltage scaling voice profile may specify a supply voltage 824 for the power amplifier 826 to produce a specified power at the output 828 when transmission information 822 is a voice waveform. In some configurations, the dynamic voltage scaling voice profile may be a lookup table.

The dynamic voltage scaling voice profile may be determined during calibration of the wireless communication device 802. For example, the wireless communication device 802 may perform calibration procedures in order to set the dynamic voltage scaling voice profile. This may be done when the wireless communication device 802 is manufactured, for instance.

The dynamic voltage scaling data profile may be derived and stored in memory based on the dynamic voltage scaling voice profile and an offset. In some configurations, the offset may be received from another communication device (e.g., base station). In some configurations, the offset may be derived based on feedback (e.g., channel feedback) from another communication device (e.g., base station). One example of the offset may be a Maximum Power Reduction (MPR) factor according to UMTS and/or LTE specifications. For instance, MPR may specify an amount of backoff (e.g., reduction in transmission power). In other examples (e.g., in accordance with CDMA specifications), the offset may be characterized based on the hardware (e.g., based on characteristics of the wireless communication device 802).

In some configurations, the dynamic voltage scaling data profile may be derived based on Equation (1). In these configurations, V_{cc} is the supply voltage 824, P_{offset} is the offset, Pₒᵤₜ is the output power at the output 828 of the power amplifier 826, Voice denotes the dynamic voltage scaling voice profile (to be applied when the transmission information 822 is a voice waveform, for example) and Data denotes the dynamic voltage scaling data profile (to be applied when the transmission information 822 is a data waveform, for example).

A voice waveform may be voice information that is formatted (e.g., encoded) particular to voice. A data waveform may be information that is formatted (e.g., encoded) for transmission as data.

The dynamic voltage scaling voice profile and/or the dynamic voltage scaling data profile may be provided to the transmit automatic gain control module 814. The transmit automatic gain control module 814 may also obtain or receive a power control signal 852. The power control signal 852 may specify an output power at the output 828 (in dBm, for example). Based on the power control signal 852, the transmit automatic gain control module 814 may provide a control signal 816 (e.g., V_{control} 816) to the switched mode power supply 820 (via the lookup table index module 854 and a filter 856 (e.g., resistor-capacitor (RC)-RC filter) in order to control the switched mode power supply 820 based on the dynamic voltage scaling voice profile and/or the dynamic voltage scaling data profile. For example, when the transmission information 822 is a voice waveform, the transmit automatic gain control module 814 may produce a control signal 816 based on the dynamic voltage scaling voice profile that causes the switched mode power supply 820 to produce a particular supply voltage 824 (e.g., V_{cc}) (corresponding to a specified power at the output 828 of the power amplifier 826, for instance). However, when the transmission information 822 is a data waveform, the transmit automatic gain control module 814 may produce a control signal 816 based on the dynamic voltage scaling data profile that causes the switched mode power supply 820 to produce a particular supply voltage 824 (corresponding to a specified power at the output 828 of the power amplifier 826, for instance).

The switched mode power supply 820 may produce a supply voltage 824 based on a battery voltage 818 (e.g., V_{batt}). For example, the switched mode power supply 820 may maintain or reduce the battery voltage 818 to produce the supply voltage 824. In some cases, the battery voltage 818 may be referred to as a nominal voltage (and the supply voltage 824 may be referred to as a nominal voltage when it is approximately the same as the battery voltage 818). The battery voltage 818 is provided by the battery. The supply voltage 824 produced by the switched mode power supply 820 may be based on the control signal 816 as described above.

The power amplifier 826 may amplify the transmission information 822 based on the supply voltage 824. For example, the amount of voltage provided by the supply voltage 824 may (partially) determine the amount of amplification provided by the power amplifier 826. The output 828 of the power amplifier 826 may be coupled to an antenna. The antenna may transmit (e.g., radiate) the transmission information 822 that has been amplified by the power amplifier 826.

It should be noted that the systems and methods disclosed herein may be applied to multiple transmit paths. For example, the wireless communication device 802 may include multiple transmit amplifiers 826 and multiple antennas in some configurations.

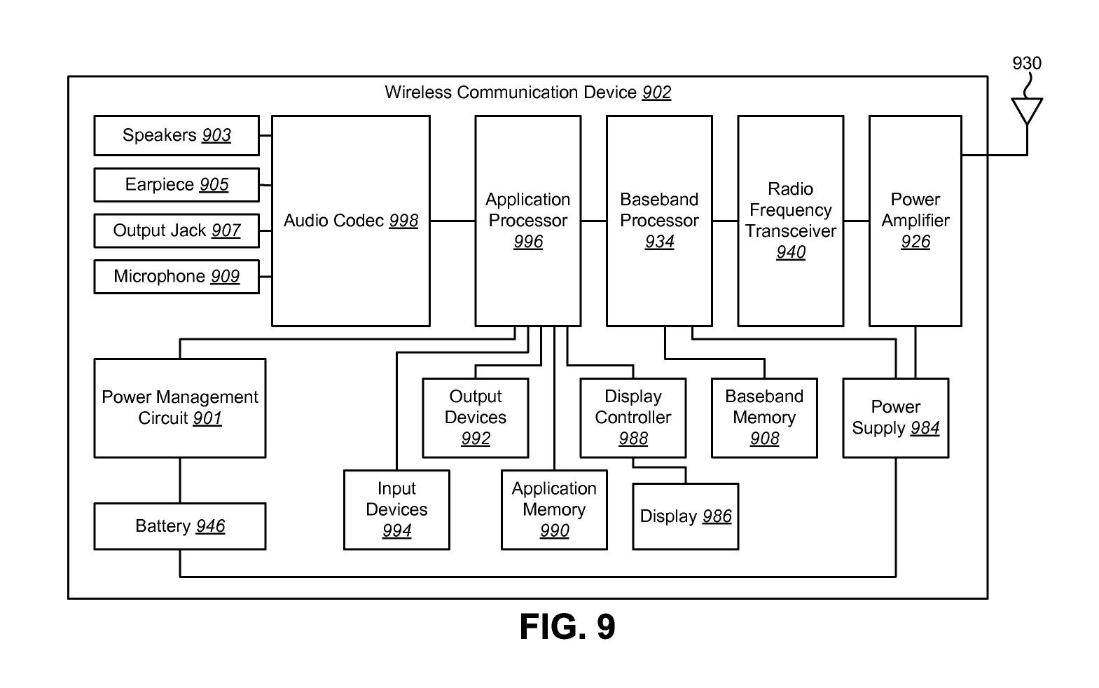

FIG. 9 is a block diagram illustrating another more specific configuration of a wireless communication device 902 in which systems and methods for deriving a dynamic voltage scaling data profile may be implemented. The wireless communication device 902 may include an application processor 996. The application processor 996 generally processes instructions (e.g., runs programs) to perform functions on the wireless communication device 902. The application processor 996 may be coupled to an audio coder/decoder (codec) 998.

The audio codec 998 may be an electronic device (e.g., integrated circuit) used for coding and/or decoding audio signals. The audio codec 998 may be coupled to one or more speakers 903, an earpiece 905, an output jack 907 and/or one or more microphones 909. The speakers 903 may include one or more electro-acoustic transducers that convert electrical or electronic signals into acoustic signals. For example, the speakers 903 may be used to play music or output a speakerphone conversation, etc. The earpiece 905 may be another speaker or electro-acoustic transducer that can be used to output acoustic signals (e.g., speech signals) to a user. For example, the earpiece 905 may be used such that only a user may reliably hear the acoustic signal. The output jack 907 may be used for coupling other devices to the wireless communication device 902 for outputting audio, such as headphones. The speakers 903, earpiece 905 and/or output jack 907 may generally be used for outputting an audio signal from the audio codec 998. The one or more microphones 909 may be one or more acousto-electric transducers that convert an acoustic signal (such as a user's voice) into electrical or electronic signals that are provided to the audio codec 998.

The application processor 996 may also be coupled to a power management circuit 901. One example of a power management circuit 901 is a power management integrated circuit (PMIC), which may be used to manage the electrical power consumption of the wireless communication device 902. The power management circuit 901 may be coupled to a battery 946. The battery 946 may generally provide electrical power to the wireless communication device 902. It should be noted that the battery 946 and/or the power management circuit 901 may be coupled to one or more (e.g., all) of the elements within the wireless communication device 902 that require power to operate.

The application processor 996 may be coupled to one or more input devices 994 for receiving input. Examples of input devices 994 include infrared sensors, image sensors, accelerometers, touch sensors, keypads, etc. The input devices 994 may allow user interaction with the wireless communication device 902. The application processor 996 may also be coupled to one or more output devices 992. Examples of output devices 992 include printers, projectors, screens, haptic devices, etc. The output devices 992 may allow the wireless communication device 902 to produce output that may be experienced by a user.

The application processor 996 may be coupled to application memory 990. The application memory 990 may be any electronic device that is capable of storing electronic information. Examples of application memory 990 include double data rate synchronous dynamic random access memory (DDRAM), synchronous dynamic random access memory (SDRAM), flash memory, etc. The application memory 990 may provide storage for the application processor 996. For instance, the application memory 990 may store data and/or instructions for the functioning of programs that are run on the application processor 996.

The application processor 996 may be coupled to a display controller 988, which in turn may be coupled to a display 986. The display controller 988 may be a hardware block that is used to generate images on the display 986. For example, the display controller 988 may translate instructions and/or data from the application processor 996 into images that can be presented on the display 986. Examples of the display 986 include liquid crystal display (LCD) panels, light emitting diode (LED) panels, cathode ray tube (CRT) displays, plasma displays, etc.

The application processor 996 may be coupled to a baseband processor 934. The baseband processor 934 generally processes communication signals. For example, the baseband processor 934 may demodulate and/or decode received signals. Additionally or alternatively, the baseband processor 934 may encode and/or modulate signals in preparation for transmission. The baseband processor 934 may be configured similarly to one or more of the baseband processors 434, 834 described above.

The baseband processor 934 may be coupled to baseband memory 908. The baseband memory 908 may be any electronic device capable of storing electronic information, such as SDRAM, DDRAM, flash memory, etc. The baseband processor 934 may read information (e.g., instructions and/or data) from and/or write information to the baseband memory 908. Additionally or alternatively, the baseband processor 934 may use instructions and/or data stored in the baseband memory 908 to perform communication operations. The baseband memory 908 may be configured similarly to one or more of the memories 108, 408, 608 described above.

The baseband processor 934 may be coupled to a radio frequency (RF) transceiver 940. The RF transceiver 940 may be coupled to a power amplifier 926 and one or more antennas 930. The RF transceiver 940 may transmit and/or receive radio frequency signals. For example, the RF transceiver 940 may transmit an RF signal using a power amplifier 926 and one or more antennas 930. The RF transceiver 940 may also receive RF signals using the one or more antennas 930. Examples of the wireless communication device 902 include cellular phones, smart phones, laptop computers, personal digital assistants (PDAs), audio players, wireless modems, gaming systems, etc. The RF transceiver 940 may be configured similarly to one or more of the transceivers 440, 840 described above.

The wireless communication device 902 may also include a power supply 984. The power supply 984 may be configured similarly to one or more of the power supplies 120, 420, 820 described above.

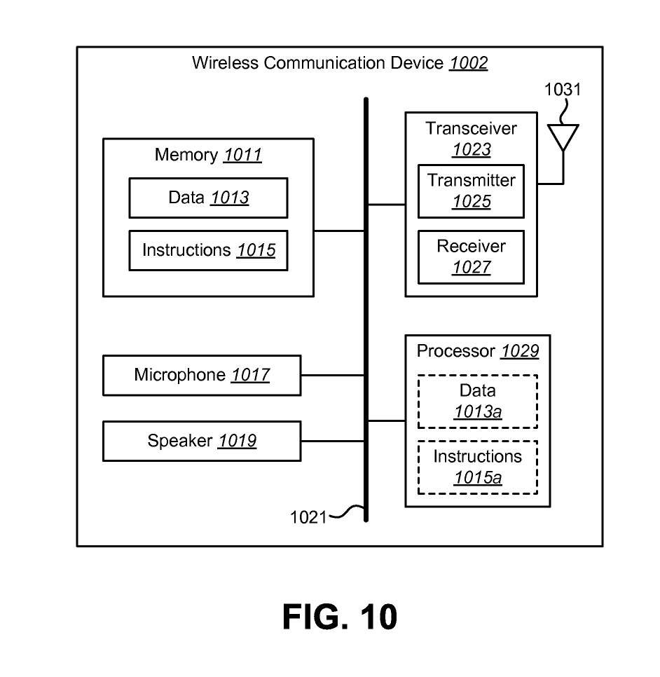

FIG. 10 illustrates certain components that may be included within a wireless communication device 1002. The wireless communication device 1002 may be configured to perform one or more of the functions described in connection with one or more of the wireless communication devices 102, 402, 802, 902 described above.

The wireless communication device 1002 includes a processor 1029. The processor 1029 may be a general purpose single- or multi-chip microprocessor (e.g., an ARM), a special purpose microprocessor (e.g., a digital signal processor (DSP)), a microcontroller, a programmable gate array, etc. The processor 1029 may be referred to as a central processing unit (CPU). Although just a single processor 1029 is shown in the wireless communication device 1002 of FIG. 10, in an alternative configuration, a combination of processors (e.g., an ARM and DSP) could be used.

The wireless communication device 1002 also includes memory 1011 in electronic communication with the processor 1029 (i.e., the processor 1029 can read information from and/or write information to the memory 1011). The memory 1011 may be any electronic component capable of storing electronic information. The memory 1011 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1013 and instructions 1015 may be stored in the memory 1011. The instructions 1015 may include one or more programs, routines, sub-routines, functions, procedures, code, etc. The instructions 1015 may include a single computer-readable statement or many computer-readable statements. The instructions 1015 may be executable by the processor 1029 to implement one or more of the methods 200, 300, 500, 700 described above. Executing the instructions 1015 may involve the use of the data 1013 that is stored in the memory 1011. FIG. 10 shows some instructions 1015a and data 1013a being loaded into the processor 1029 (which may come from instructions 1015 and data 1013).

The wireless communication device 1002 may also include a transmitter 1025 and a receiver 1027 to allow transmission and reception of signals between the wireless communication device 1002 and a remote location (e.g., another electronic device, wireless communication device, etc.). The transmitter 1025 and receiver 1027 may be collectively referred to as a transceiver 1023. An antenna 1031 may be electrically coupled to the transceiver 1023. The wireless communication device 1002 may also include (not shown) multiple transmitters, multiple receivers, multiple transceivers and/or multiple antenna.

In some configurations, the wireless communication device 1002 may include one or more microphones 1017 for capturing acoustic signals. In one configuration, a microphone 1017 may be a transducer that converts acoustic signals (e.g., voice, speech) into electrical or electronic signals. Additionally or alternatively, the wireless communication device 1002 may include one or more speakers 1019. In one configuration, a speaker 1019 may be a transducer that converts electrical or electronic signals into acoustic signals.

The various components of the wireless communication device 1002 may be coupled together by one or more buses, which may include a power bus, a control signal bus, a status signal bus, a data bus, etc. For simplicity, the various buses are illustrated in FIG. 10 as a bus system 1021.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A wireless communication device for deriving a dynamic voltage scaling data profile, comprising:
memory that includes a dynamic voltage scaling voice profile; and
a data profile determination module coupled to the memory, wherein the data profile determination module obtains an offset and derives a dynamic voltage scaling data profile by offsetting the dynamic voltage scaling voice profile based on the offset.

2. The wireless communication device of claim 1, wherein the dynamic voltage scaling voice profile indicates supply voltages corresponding to powers for a voice waveform.

3. The wireless communication device of claim 1, further comprising a power supply, wherein the power supply provides a supply voltage to an amplifier based on the dynamic voltage scaling data profile if a data waveform is going to be transmitted.

4. The wireless communication device of claim 1, wherein the dynamic voltage scaling voice profile is determined during calibration.

5. The wireless communication device of claim 1, wherein the dynamic voltage scaling voice profile is based on a power supply characterization table.

6. The wireless communication device of claim 1, wherein the memory includes a first sweep calibration table that is based on performing a first sweep calibration, and wherein the dynamic voltage scaling voice profile is based on performing a second sweep calibration.

7. The wireless communication device of claim 1, wherein the data profile determination module derives the dynamic voltage scaling data profile based on an equation V_{cc}(Data, Pₒᵤₜ)≧V_{cc}(Voice, Pₒᵤₜ+P_{offset}+1), wherein Data denotes a data waveform, Voice denotes a voice waveform, Pₒᵤₜ is an output power, P_{offset} is the offset and V_{cc}( ) indicates a supply voltage V_{cc} based on a waveform type and the output power.

8. The wireless communication device of claim 1, wherein the offset is a power offset.

9. The wireless communication device of claim 1, wherein the offset is a maximum power reduction factor.

10. The wireless communication device of claim 1, wherein the dynamic voltage scaling data profile is not based on a separate calibration for data waveforms.

11. The wireless communication device of claim 1, further comprising a controller that applies a fixed voltage offset versus output power as a function of modulation type.

12. A method for deriving a dynamic voltage scaling data profile by a wireless communication device, comprising:
obtaining a dynamic voltage scaling voice profile;
obtaining an offset; and
deriving a dynamic voltage scaling data profile by offsetting the dynamic voltage scaling voice profile based on the offset.

13. The method of claim 12, wherein the dynamic voltage scaling voice profile indicates supply voltages corresponding to powers for a voice waveform.

14. The method of claim 12, further comprising providing a supply voltage to an amplifier based on the dynamic voltage scaling data profile if a data waveform is going to be transmitted.

15. The method of claim 12, wherein the dynamic voltage scaling voice profile is determined during calibration.

16. The method of claim 12, wherein the dynamic voltage scaling voice profile is based on a power supply characterization table.

17. The method of claim 12, wherein obtaining a dynamic voltage scaling voice profile comprises:
performing a first sweep calibration; and
performing a second sweep calibration.

18. The method of claim 12, wherein deriving the dynamic voltage scaling data profile is based on an equation V_{cc}(Data, Pₒᵤₜ)≧V_{cc}(Voice, Pₒᵤₜ+P_{offset}+1), wherein Data denotes a data waveform, Voice denotes a voice waveform, Pₒᵤₜ is an output power, P_{offset} is the offset and V_{cc}( ) indicates a supply voltage V_{cc} based on a waveform type and the output power.

19. The method of claim 12, wherein the offset is a power offset.

20. The method of claim 12, wherein the offset is a maximum power reduction factor.

21. The method of claim 12, wherein the dynamic voltage scaling data profile is not based on a separate calibration for data waveforms.

22. The method of claim 12, further comprising applying a fixed voltage offset versus output power as a function of modulation type.

23. A computer-program product for deriving a dynamic voltage scaling data profile, comprising a non-transitory tangible computer-readable medium having instructions thereon, the instructions comprising:
code for causing a wireless communication device to obtain a dynamic voltage scaling voice profile;
code for causing the wireless communication device to obtain an offset; and
code for causing the wireless communication device to derive a dynamic voltage scaling data profile by offsetting the dynamic voltage scaling voice profile based on the offset.

24. The computer-program product of claim 23, the instructions further comprising code for causing the wireless communication device to provide a supply voltage to an amplifier based on the dynamic voltage scaling data profile if a data waveform is going to be transmitted.

25. The computer-program product of claim 23, wherein the dynamic voltage scaling voice profile is determined during calibration.

26. The computer-program product of claim 23, wherein the code for causing the wireless communication device to obtain a dynamic voltage scaling voice profile comprises:
code for causing the wireless communication device to perform a first sweep calibration; and
code for causing the wireless communication device to perform a second sweep calibration.

27. The computer-program product of claim 23, wherein the code for causing the wireless communication device to derive the dynamic voltage scaling data profile is based on an equation V_{cc}(Data, Pₒᵤₜ)≧V_{cc}(Voice, Pₒᵤₜ+P_{offset}+1), wherein Data denotes a data waveform, Voice denotes a voice waveform, Pₒᵤₜ is an output power, P_{offset} is the offset and V_{cc}( ) indicates a supply voltage V_{cc} based on a waveform type and the output power.

28. The computer-program product of claim 23, the instructions further comprising code for causing the wireless communication device to apply a fixed voltage offset versus output power as a function of modulation type.

29. An apparatus for deriving a dynamic voltage scaling data profile, comprising:
means for obtaining a dynamic voltage scaling voice profile;
means for obtaining an offset; and
means for deriving a dynamic voltage scaling data profile by offsetting the dynamic voltage scaling voice profile based on the offset.

30. The apparatus of claim 29, further comprising means for providing a supply voltage to an amplifier based on the dynamic voltage scaling data profile if a data waveform is going to be transmitted.

31. The apparatus of claim 29, wherein the dynamic voltage scaling voice profile is determined during calibration.

32. The apparatus of claim 29, wherein the means for obtaining a dynamic voltage scaling voice profile comprises:
means for performing a first sweep calibration; and
means for performing a second sweep calibration.

33. The apparatus of claim 29, wherein the means for deriving the dynamic voltage scaling data profile is based on an equation V_{cc}(Data, Pₒᵤₜ)≧V_{cc}(Voice, Pₒᵤₜ+P_{offset}+1), wherein Data denotes a data waveform, Voice denotes a voice waveform, Pₒᵤₜ is an output power, P_{offset} is the offset and V_{cc}( ) indicates a supply voltage V_{cc} based on a waveform type and the output power.

34. The apparatus of claim 29, further comprising means for applying a fixed voltage offset versus output power as a function of modulation type.
